(19) United States
(12) Patent Application Publication
(10) Pub. No.: US 2007/0010189 A1
(43) Pub. Date: Jan. 11, 2007

(54) Housing for an air conditioning system

(76) Inventor: Gunnar Dietrich, Mannheim (DE)

Correspondence Address: DEERE & COMPANY, ONE JOHN DEERE PLACE, MOLINE, IL, 61265, US

(21) Appl. No.: 11/475,713

(22) Filed: Jun. 27, 2006

(30) Foreign Application Priority Data
Jul. 9, 2005 (DE) 10 2005 032 251.4

(51) Int. Cl. B60H 3/06

(52) U.S. Cl. 454/158

(57) ABSTRACT

The invention relates to a housing for an air conditioning system. There is a need for an air conditioning system housing which can be manufactured at low cost and which can withstand the higher pressures of an air conditioning system which uses CO2. The present invention provides a housing which includes walls and a woven reinforcing fabric consisting of plastic fibers. The walls are sheathed on their inner sides with the woven reinforcing fabric.

### BACKGROUND

The present invention relates to a housing for an air conditioning system that includes walls and a woven reinforcing fabric of plastic fibers.

In present vehicle air conditioning (AC) systems the refrigerant R134a is usually used. Depending on the system and the temperatures of the surroundings, refrigerant pressures up to approximately 20 bar can occur during operation. At the present time C systems are being developed using CO2 as refrigerant, since CO2 is one of the most environment-friendly refrigerants. However, using CO2 as refrigerant results in clearly higher density than R134a, and the compressor and other components of the AC system must be designed for clearly higher pressures than the components of a system with R134a. Such pressures could run as high as approximately 130 bar. If a leak occurs in an AC system operated with CO2, due to a defect such as defective brazed joint, then the plastic housing which normally encloses the system would not be adequate to protect the occupants.

DE 20 2004 007 708 U describes a compressor that is compatible with the higher pressures that are encountered in an AC system operating with CO2. The compressor comprises a reinforced cylinder block. Indeed, as noted above, other components of the AC system must also be operated at higher pressures, so that the reinforcement of the compressor alone is not sufficient.

DE 36 31 975A shows a dryer container for an AC system whose housing is composed of an inner thin-walled support body with an outer impermeable wrapped coating of glass fibers and an adhesive. This is expected to be lighter in weight than a steel dryer housing. However, only the dryer container is designed for higher pressures, but not the supply lines and the other components of an AC system.

DE 91 06 594 U describes a rectangular housing of the type described above for ventilation and AC implements with wall elements manufactured as one-piece components from plastic reinforced with fibers (preferably glass fibers) whose cover elements are provided with edge strips arched upward that are bolted to the side walls. This is intended to create a housing that is resistant to torques and is corrosion proof. The wall elements and the reinforcing fibers are manufactured as one-piece components which are rather costly and expensive.

### SUMMARY

Accordingly, an object of this invention is to provide a housing for an air conditioning system that can be manufactured simply and at low cost, which assures an adequate margin of safety for the occupants of a vehicle even during operation with CO2.

This, and other objects are met according to the invention wherein a housing has walls which are sheathed on their inner sides with a woven reinforcing fabric that preferably consists of high strength fibers, for example, Kevlar. Accordingly there are at least two layers of the woven reinforcing fabric. An inner layer of the woven reinforcing fabric protects against explosions of the air conditioning system, and an outer layer mechanically supports, retains and stabilizes the housing and the air conditioning system. The result is a housing for an air conditioning system that can be manufactured simply and at low cost and that is also appropriate for operation with CO2 as refrigerant. Moreover the woven reinforcing fabric also provides a thermal insulation for the air conditioning system as long as it is provided with sufficient thickness.

An aluminum foil can be arranged on the inner and/or the outer side of the woven reinforcing fabric. The woven reinforcing fabric can be fastened to the walls by velcro or any other desired means, for example, adhesive, snaps, screws, rivets etc.

### BRIEF DESCRIPTION OF THE DRAWINGS

FIG. 1 is a partial sectional side view of a housing and the components of an air conditioning system arranged within it; and

FIG. 2 is a cross sectional view of the side wall of the housing.

### DETAILED DESCRIPTION

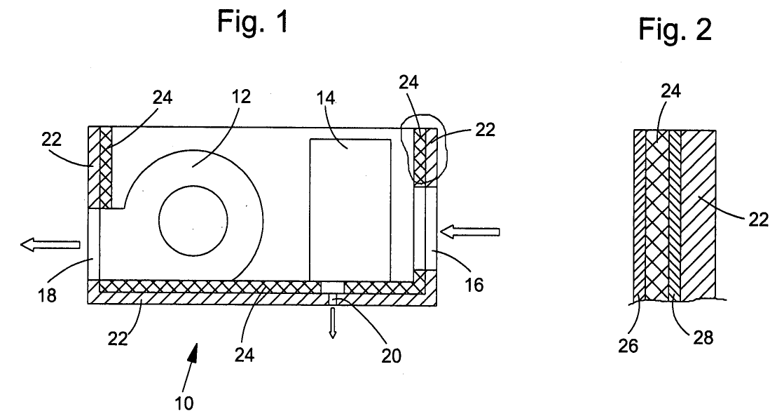

Referring to FIG. 1, components of a known conventional air conditioning system, such as a ventilator 12 and a compressor 14, are arranged in the housing 10. The housing 10 includes an opening 16 used as air inlet, an opening 18 used as air outlet and an opening 20 at the floor used for the drainage of condensate.

The housing 10 includes plate-shaped walls 22 that consist of plastic or metal, for example, steel or aluminum. A woven reinforcing fabric 24 of high strength plastic fibers, such as Kevlar, is arranged at the inner side of the walls 22. The entire inner surface of the housing 10, except for the openings 16, 18, 20, is sheathed with the woven reinforcing fabric 24.

As can be seen from FIG. 2, an aluminum foil 26 is located on the inner side of the woven reinforcing fabric 24. A further aluminum foil 28 is located between the woven reinforcing fabric 24 and the wall 22.

The housing 10 can be manufactured at low cost. If the air conditioning system is operated with CO2 as refrigerant, the woven reinforcing fabric provides an adequate protection for occupants against any possible exploding components of the air conditioning system. Moreover, in interaction with the aluminum foil 26, 28, it insulates thermally the components arranged in the housing 10. A further layer with a woven reinforcing fabric could also be attached to the outside of the housing 10.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A housing for an air conditioning system, the housing having walls and a woven reinforcing fabric of plastic fibers, characterized by:
the inner sides of the walls are sheathed with the woven reinforcing fabric.

2. The housing of claim 1, wherein:
an aluminum foil is arranged on a side of the woven reinforcing fabric.

3. The housing of claim 1, wherein:
the woven reinforcing fabric consists of high strength fibers.

4. The housing of claim 1, wherein:
a compressor and a ventilator are arranged in the housing.
